(19) United States
(12) Patent Application Publication
(10) Pub. No.: US 2024/0430172 A1
(43) Pub. Date: Dec. 26, 2024

(54) METHODS, ARCHITECTURES, APPARATUSES AND SYSTEMS FOR CONTINUOUS ASSESSMENT, TRAINING AND DEPLOYMENT OF AI/ML MODEL

(71) Applicant: InterDigital CE Patent Holdings, SAS, Paris (FR)

(72) Inventors: Pascal Le Guyadec, Saint Gregoire (FR); Cyril Quinquis, Melesse (FR); Thierry Filoche, Chateaugiron (FR); Stephane Onno, Saint Gregoire (FR)

(21) Appl. No.: 18/294,907

(22) PCT Filed: Jul. 29, 2022
(86) PCT No.: PCT/EP2022/071451

§ 371 Date: Feb. 2, 2024

(30) Foreign Application Priority Data
Aug. 5, 2021 (EP) 21306094.0

(51) Int. Cl. H04L 41/16; G06N 20/00; H04L 41/14; H04L 41/5009; H04W 28/02

(52) U.S. Cl. CPC H04L 41/16; G06N 20/00; H04L 41/145; H04L 41/5009; H04W 28/0268

(57) ABSTRACT

Procedures, methods, architectures, apparatuses, systems, devices, and computer program products of machine learning using a first machine learning (ML) module implementing a first ML model and a second ML module implementing a second ML model, the method comprising: receiving, by the second ML module, first prediction results of the first ML model, the first prediction results being based on input data; generating, by the second ML module, second prediction results using the second ML model based on the input data; determining, by the second ML module, an accuracy metric based on a comparison of the first prediction results of the first ML model and the second prediction results of the second ML model; and sending, by the second ML module, the determined accuracy metric and an accuracy condition.

### FIELD

The present disclosure is generally directed to the fields of communications, software and encoding, including, for example, to methods, architectures, apparatuses, systems directed to assessment, training and/or deployment of AI/ML (Artificial Intelligence/Machine Learning) models.

### BACKGROUND

The AI/ML techniques can be used in various domains, such as image enhancement, audio noise reduction, automatic translation, and navigation. This new intelligence can be accomplished by processing and interpreting precisely and quickly the tremendous amount of data generated by the sensors embedded in the devices, e.g., camera, microphone, thermometer. These sensors aim at reflecting what happens in the close vicinity of the device. Thus, environment change will impact the final application and the user experience.

Building Machine Learning models that perform well in the wild at production time is still an open and challenging problem: the discrepancy between examples seen during training and those used at inference time can cause a drop in accuracy's performance of AI/ML models in production. The management of the quality of those Service based on AI/ML models may need a model performance feedback attached to the inference node to ensure a continuous assessment of the quality of those deployed Services.

### SUMMARY

According to an embodiment, a method of machine learning using a first ML module implementing a production ML model and a second ML module implementing a reference ML model, different from the production ML model is presented, the method comprising: receiving, by the second ML module, first prediction results of the production ML model, the first prediction results being based on input data; generating, by the second ML module, second prediction results using the reference ML model based on the input data; determining an accuracy metric based on a comparison of the first prediction results of the production ML model and the second predictions results of the reference ML model; and on condition that the accuracy metric indicates an accuracy not satisfying an accuracy condition, updating the production ML model.

Further embodiments include systems configured to perform the methods described herein. Such systems may include a processor and a non-transitory computer storage medium storing instructions that are operative, when executed on the processor, to perform the methods described herein.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an overview of a system diagram flow for assessment, training and/or deployment of AI/ML models, according to an embodiment;

FIG. 3 illustrates an overview of a diagram flow for retraining AI/ML models, according to an embodiment;

FIG. 4 illustrates an overview of a system architecture for assessment, training and/or deployment of AI/ML models, according to an embodiment;

FIG. 5 illustrates an overview of a data collector node, according to an embodiment;

FIG. 6 illustrates an inference/reference model;

FIG. 7 illustrates an example of the service architecture for AI/ML model delivery;

FIG. 8 is a diagram illustrating an example of a method of machine learning, according to an embodiment; and

FIG. 9 is a diagram illustrating an example of a method of machine learning, according to another embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

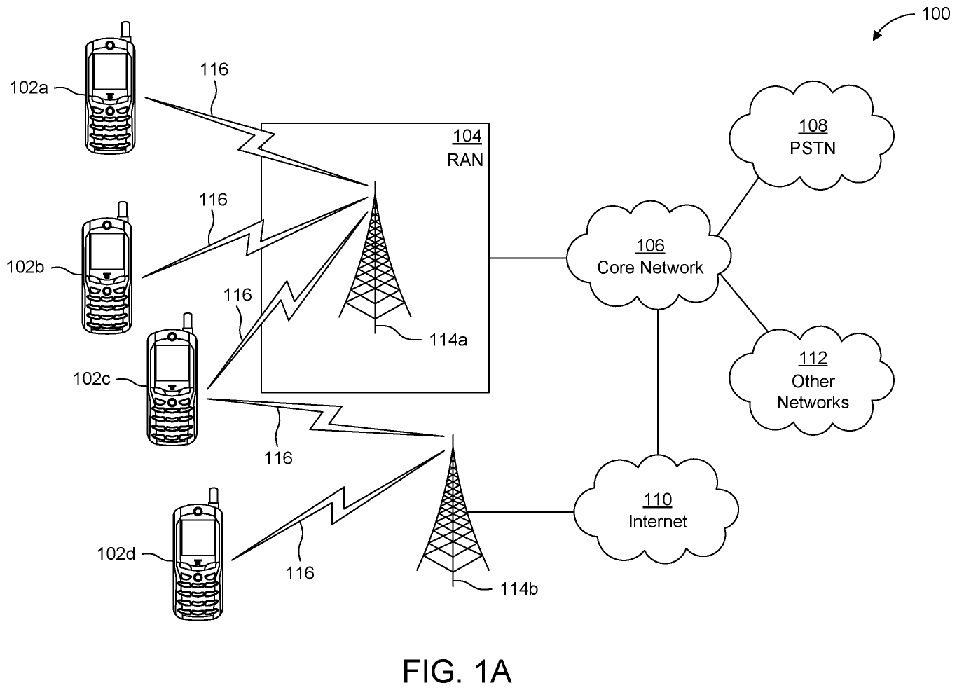

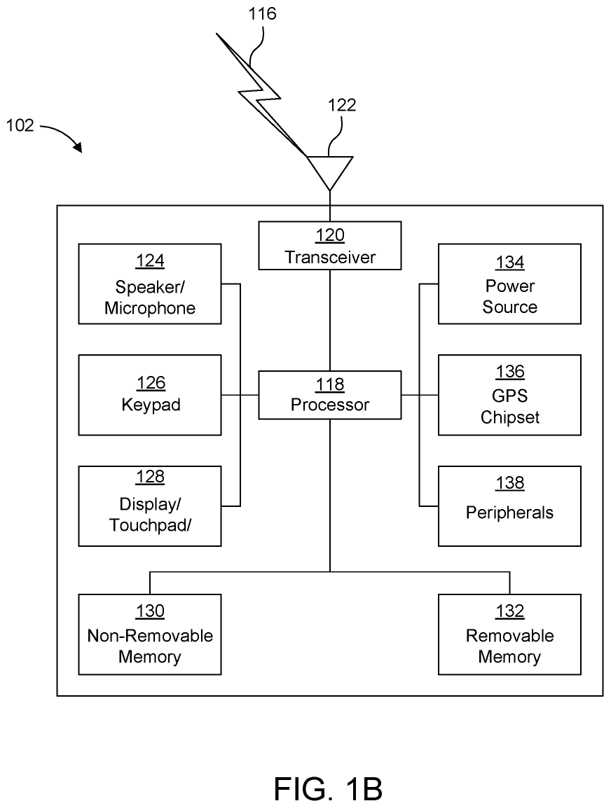

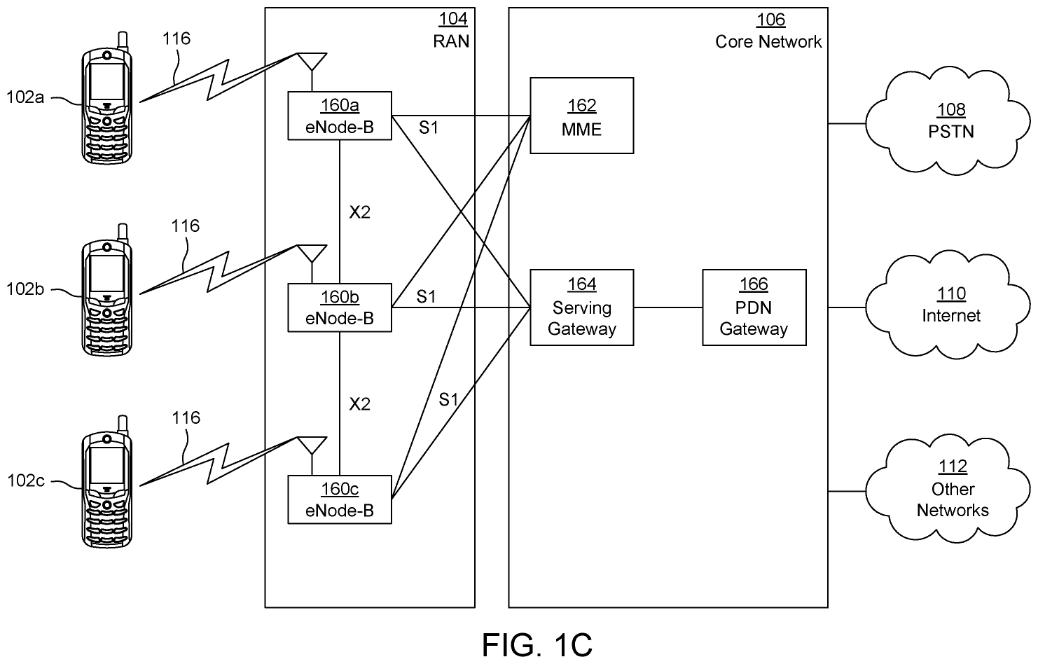

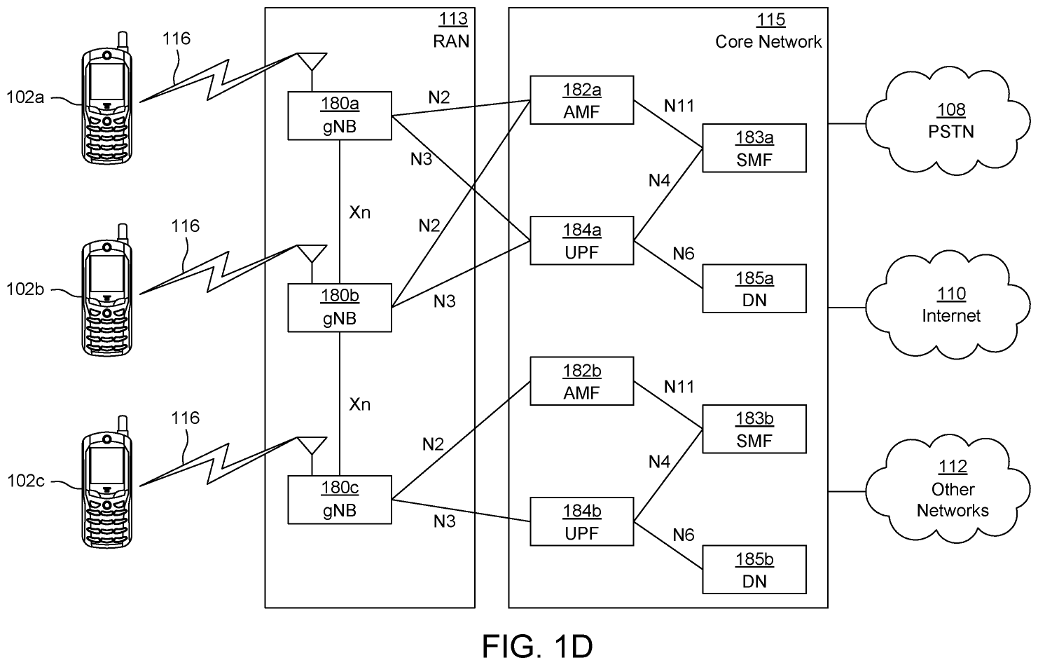

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU 102 (e.g. UE).

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHZ, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Usually, the performance of a supervised AI/ML Model may be done at training phase, by using a dedicated part of the dataset (e.g. the validation dataset). The real accuracy of the system may differ depending on current input data, environment and context encounter during production. To evaluate the real accuracy of models that are deployed and running on the field, an up-to-date validation dataset based on the real data may be (e.g. needed) used. Any test, training or validation dataset may be a labeled dataset: each entry in the dataset should be composed of a set of inputs and its associated ground truth.

Depending on the type of tasks solved by those models, an “in-production labeled test set” may not be available and affordable. In some tasks like short or mid-term prediction (for example bandwidth prediction, user activity/presence prediction, handover prediction) it may be straightforward to create this ground truth just by waiting the appropriate time and get the measured values. In other tasks, for example image classification/recognition or speech recognition, it may be almost impossible to do it automatically: this, usually may use (e.g. need) some manual validation and labelization. For some tasks, the labelization process may be set automatically (auto-labelization), for others this process may not be automatized because it may use (e.g. request) some extra efforts and/or manual operations that may be incompatible with production environment.

The disclosure is primarily targeting models that are not easily self-labelable: by introducing a method to provide an “estimate ground truth” (or pseudo-ground truth) that may be used to quantify the model accuracy on the data encounter in production and/or to detect misbehavior or accuracy's drift on the deployed models.

An embodiment of the disclosure is to use a second model with a better accuracy than the deployed one to serve as a reference model. The embodiment may use such Reference models that are known to be more accurate and may run them on some selected real input data. Those data may be collected on the system during production phase. The system may compare the output of the deployed model and the output of those reference models: it may track differences of the outputs and/or detect inconsistencies. The Reference models may not need to run in real time or on the targeted deployed node. Those Reference models may run on more powerful platforms (even in cloud services) in batch mode (not in real time). In addition to quality tracking, the system may use the collected data and the pseudo ground truth provided by the reference model to improve the accuracy of the deployed model in the retraining process.

New methods to palliate the above-mentioned problems are described, by considering one or more of the follows:
Method to use reference models in order to track performances of the deployed model.
Method to retrain model based on the collected data.

Usually models that can be deployed on production platforms may be not the ones that can achieve the best accuracy. Indeed, in production, deployed models may be often the result of a compromise between accuracy and efficiency. Deployed models may be usually limited because of resources constraints or process optimizations required by the Environment or the Service. These constraints maybe of any of the following types: processing nodes constraints (processing power or memory resource available on the node), service latency constraints (request execution time should not exceed a threshold), or energy saving constraints (the energy consumption needed to run inferences should be limited). All these additional constraints/optimizations may usually impact the level of accuracy of the Service delivered by the deployed model.

### 1 Overview

According to an embodiment, a process may use the output delivered by those Reference models to (e.g., continuously) assess the accuracy of the deployed model. This process may be built over the any of the 4 main following steps:
1. Data Collection creation: using any sampling method, the system may collect both real data inputs and the corresponding output processed by the deployed model (“on production” model).
2. For each collected input, fill in the Collection with the processed results provided by the reference(s) model(s).
3. Compute an estimated accuracy based on values calculated by the reference(s) model(s).
4. Update the model used in production: either by selecting a new one, retraining it (ML Domain Adaptation) and/or change some configuration parameters when possible (e.g. flexible model). Use the new set of input data labeled by the reference Model.

### 2 Main Components

Here are the main actors and components that may be involved in the system:
Model Administration and Maintenance: this module may be in charge of the management of deployed models and assesses the quality of the AI/ML Service.
Data Sources: set of data used as input in the AI/ML inference process. These data may be composed of different type of data (image, sound, key metrics, etc.) and may be produced by different devices.
Inferer: node that may host the deployed model and compute inferences based on the input data provided by the Data Sources.
Actor: process that may use the deployed Model inference outputs to deliver a Service or perform actions.
Collector Agent: entity that may be responsible of filtering inputs and outputs that may (e.g. need to) collected. It may apply the sampling policy set by the Model Administrator and Maintenance.
Data Storage: entity that may store the selected data input and the associated results from deployed models and the reference models. (E.g. each) Item in the collection may be composed of the input data, some potential extra input data, the output of the “production model” and the output(s) of the reference(s) model(s).
Reference Inferer: node that may compute Reference Model inferences outputs using one or several reference models.

### 3 Detailed Process Description

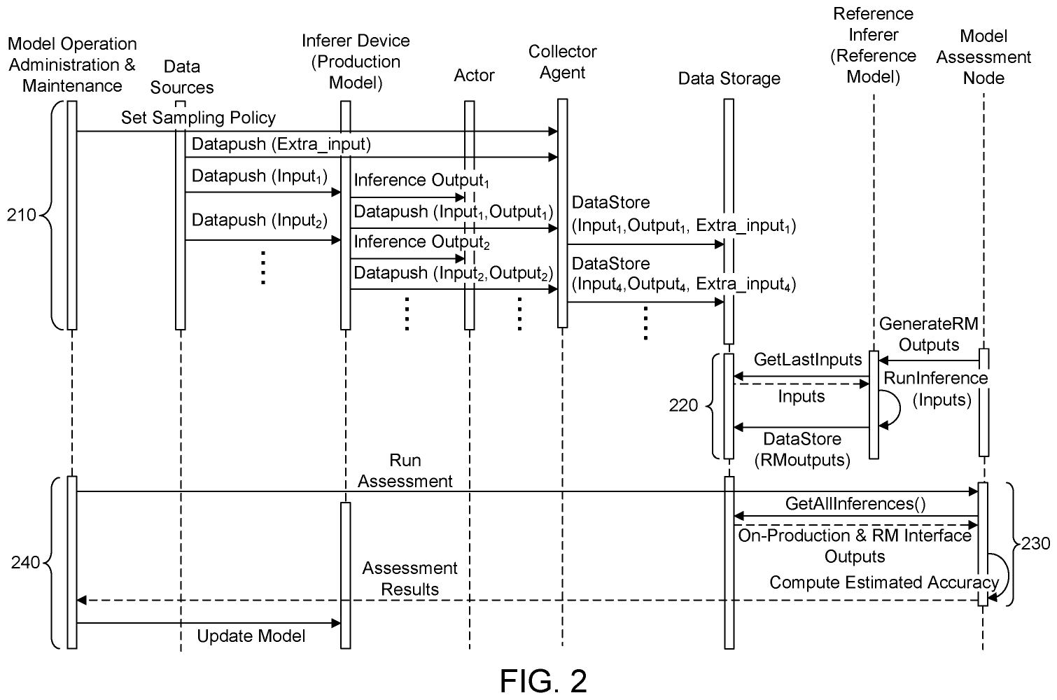

FIG. 2 illustrates the 4 main steps operations and typical interactions that may occur between the different actors and modules.

The 4 steps are detailed below:

Step 210: Data Collection Creation: this process may create a data collection of inputs relative to conditions encountered on production. This collection may be sufficiently large (for example >100 records) (e.g. to be able) to provide a good statistical accuracy value. These data may be collected according to any sampling strategy: for example, it may be a regular sampling method, where a new sample may be recorded every n seconds on a regular basis whatever the values of input recorded. Another strategy may be to use a fully randomized sampling vector: the inputs may be selected based on a random selector. Another strategy may be to store values according to inputs data values (stratified or clustering sampling techniques). At this stage, the Data Collection may be composed of records that include only the selected inputs.

Simultaneously with the input collection, the system may add the deployed model output to the Data Collection: for each item (input) stored in the Collection, the deployed model output may be recorded. The model output may be composed of different values: for example, for a classification task this output may be composed of the selected class and its associated confidence score. Both these values may be used to filter out the item in the collection. At this stage, each record of the Data Collection may be composed of input and its associated output computed by the deployed model.

Some reference models may use (e.g. require) more features or additional data to run: if those data are available, the system may (e.g. need to) collect them. At this stage, each record of the Data Collection may be completed with additional inputs.

Step 220: Apply the reference model on the collected data: When possible, at a given time and/or periodicity (for example once a day, once a week), each data collected may be processed using the reference model and the resulting outputs may be stored in the collected data. Since those results may not need to be used in real time, those processes may be executed in batch mode, without any constraint in the latency of execution. This processing may not need to run on the node used in production: when (e.g., as soon as) the data may be sufficiently secured and the privacy of the data may be preserved, those inferences may be run on any distant server. The reference model may be more accurate than the in-production model and/or may use (e.g., require) more resources (process, memory, time, energy) to provide a more accurate response. At this stage, each record of the Data Collection may include the corresponding output(s) processed by the reference(s) model(s)

Step 230: Compute an estimated accuracy based on the outputs of the production and the reference models for each item of the collection. According to embodiments, one method may be to use the result of the reference model as the ground truth for accuracy measurement: this may provide an estimated accuracy for the production model. This first method may be applied when references models exhibit very strong accuracy. According to embodiments, another method may be to use both the result of the reference model and its confidence score. The confidence score may be used to filter out the samples where the results may be too ambiguous or may be subject to inaccuracy: in that case, the estimated accuracy calculation based on ground truth provided by the reference(s) model(s) may be done (e.g. only) on the samples where the confidence score may be higher than a threshold (for example above 75%). Another way to use those confident score, may be to weight each individual score by the reference model's confidence score value: this may minimize the impact of the wrong “ground truth” provided by the reference model results.

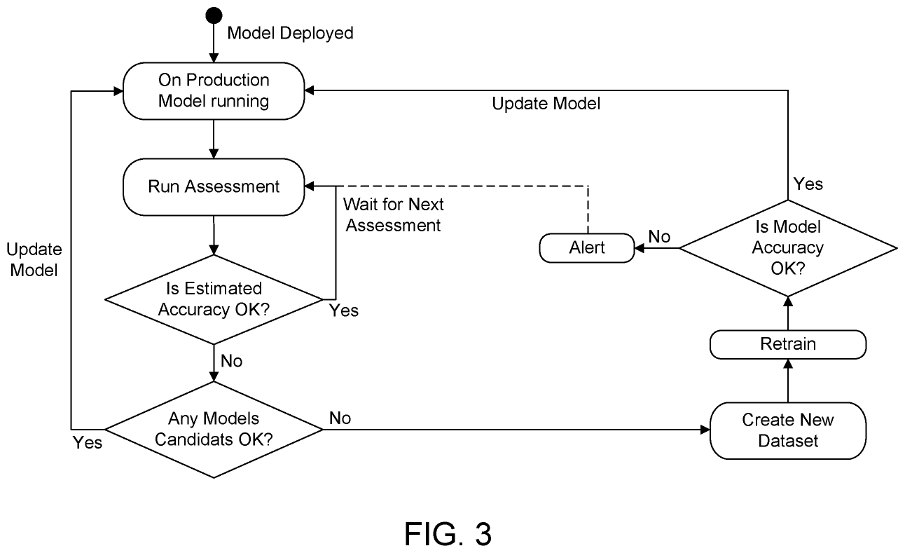

Step 240. If the estimated accuracy is not anymore sufficient (for example, accuracy drops below a certain threshold), then the production model may (e.g. need to) be updated: the model may be either fully changed (select one among other possible candidates), or re-trained using additional data, or reparametrized (in case of flexible models). FIG. 3 illustrates an example of model assessment with retraining process.

If, among other models that fit the deployment requirements (pools of candidate models), one is more accurate (tested on the last set of data collected on the field), then the system may deploy and use it in replacement of the previous one.

In some case, model re-training may fix the accuracy drop: in such case, it may be very useful to include the last collected data into the training dataset to mitigate the errors and improve the model accuracy in production. This means that the system may create a new dataset which may be a mix of the old dataset with new samples composed of collected input, plus pseudo ‘ground truth’ computed by the references models. This new dataset may carefully include those new samples by selecting only the records where the score confidence computed by the reference model may be sufficiently high (for example >75%) in order to not include too many wrongly labeled samples into the training.

If after the retraining process, the newly re-trained model does not provide a sufficient accuracy, the system may (e.g. send an alert to) notify the Service that something may be probably not as good as expected, and or need control/maintenance (for example to notify a final user).

### 4 Typical Block Architecture Implementation

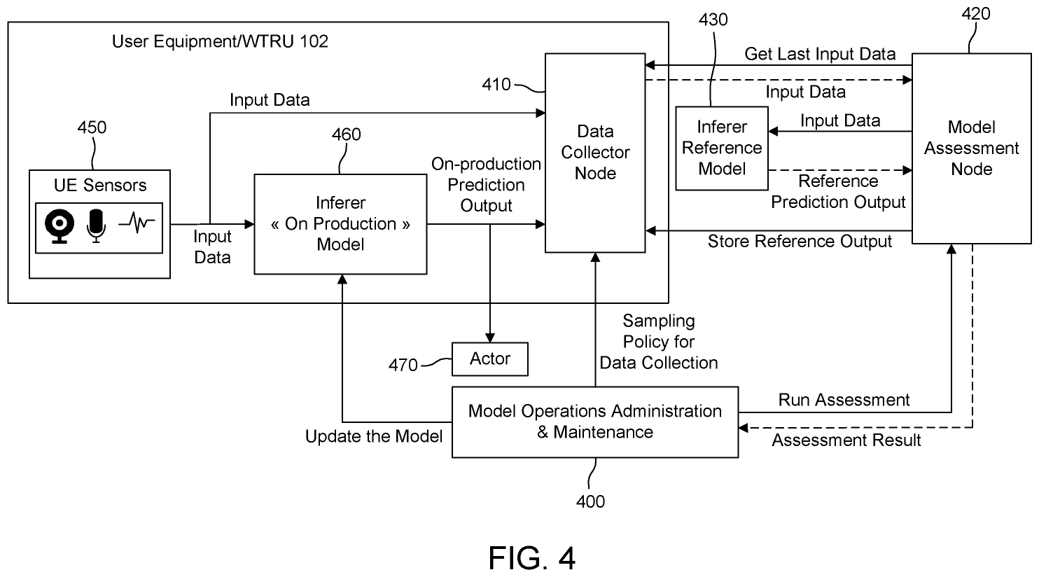

As soon as all devices are reachable from each other, each block/entity/module listed in the disclosure may be implemented on any devices. When a device has limited connectivity, for example a WTRU 102 (e.g. UE), it may be wise to group together Sensors, ‘on production’ Inferer and the Data Collector node as illustrated in FIG. 4. Indeed those blocks may consume continuously a lot of data. They may use (e.g. need) both a large bandwidth without any link discontinuities. Those blocks may (e.g. need to) be tightly coupled inside the WTRU 102 (e.g. UE).

### 4.1 Block 410: Data Collector Node

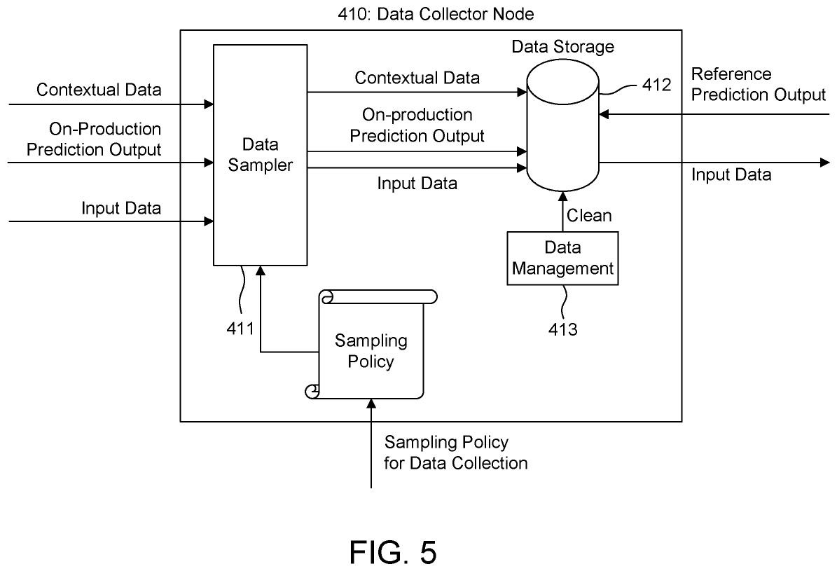

This entity/module may filter inputs and outputs that may (e.g. need to) be collected. It may be also responsible for storing data from modules [420], [460], [450], it is illustrated by FIG. 5. The storage may be performed in the entity [412].

### 4.2 Block 411: Data Sampler

The Model operations Administrations and Maintenance may set a sampling policy that may fit a Data Sampler module [411]. The Sampling Policy may define different settings like any of: collecting duration, collecting start date, collecting end date, amount of data to be collected or sampling methodology (one among those methodologies described above in section 3).

The sampled data may be then stored in a specific entity [412].

### 4.3 Block 412: Data Storage

This entity/module may store the selected data input and the associated results from deployed models and the reference models. (E.g. each) Item in the collection may be composed of the input data, some potential extra input data, the output of the “production model” and the output(s) of the reference(s) model(s).

### 4.4 Block 413: Data Management Storage

The entity/module may manage the limited amount of storage space available on the Collector Node. It may be responsible to remove all the outdated data and make sure fresh data may be stored in the WTRU 102 (e.g. UE) equipment.

### 4.5 Block 420: Model Assessment Node

This module may be in charge to compute the estimated accuracy based on the comparison of on-production model predictions and the corresponding reference models predictions. Predicted outputs of all the models may be fetched from the data storage entity [412].

### 4.6 Block 300: Inference/Reference Model

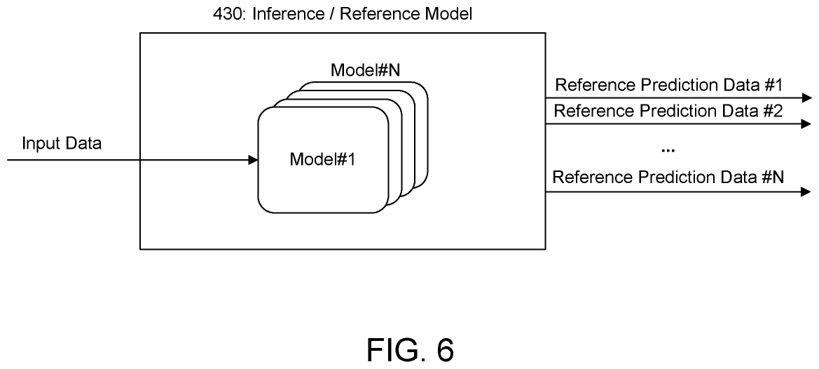

This module may have some processing units (CPU, GPU, NPU, ASICs, FPGA . . . ) and memory and may be able to execute one or more performant AI/ML models, e.g. inference/reference models as illustrated in FIG. 6. At least one AI/ML model may deliver a prediction with a significant score. The output prediction data may be stored by the data storage entity [412].

### 4.7 Block 400: Model Operations Administration and Maintenance

This module may be in charge of the management of deployed models and may assess the quality of the AI/ML Service. It may set the sampling policy used by the collector node [410].

4.8 Block 450: WTRU (e.g. UE) Sensors

The WTRU 102 (e.g. UE) may embed various sensors that may produce a huge amount of sensing data that may be interpreted by dedicated AI/ML models. As an example, cameras are common and typical sensors that may be used to detect and recognize objects. They may produce raw RGB data that may be pre-processed and then may fit an AI/ML model which may infer and may return a prediction, for instance an object label with a confidence score. Data from may fit both the block which may be the module that may perform the on-production inference and the block that may select the data input that may (e.g. need to) be kept in the data storage [412] for further processing.

### 4.9 Block 460: Inference/On-Production Model

This module may host the on-production model and may compute inferences in real time based on the input data provided by the Data Sources [450].

### 4.10 Block 700: Actor

This node may use the deployed Model inference outputs to deliver a Service or perform actions.

### 5 Video AI/ML Delivery

### 5.1 Post Processing Use-Case

A neural network (NN) may apply post-processing to a decoded video sequence to enhance the video quality. The post-processing may be outside the coding loop and may not impact the decoding of the video itself. Possible post-processing algorithms may include any of:
Post-filtering: a NN is applied on the output of the video decoder to improve the quality. Such improvements may include video coding artifacts removal, subjective quality enhancement etc.
Super resolution: a NN is applied on the output video sequence if (e.g., when) the resolution of the display is greater than the resolution of the decoded video. NN based approaches may allowed for subjectively increased quality during the resampling process.
NN based HDR enhancement: a NN is applied for example to enhance a SDR video into an HDR-looking video.

### 5.2 Architecture

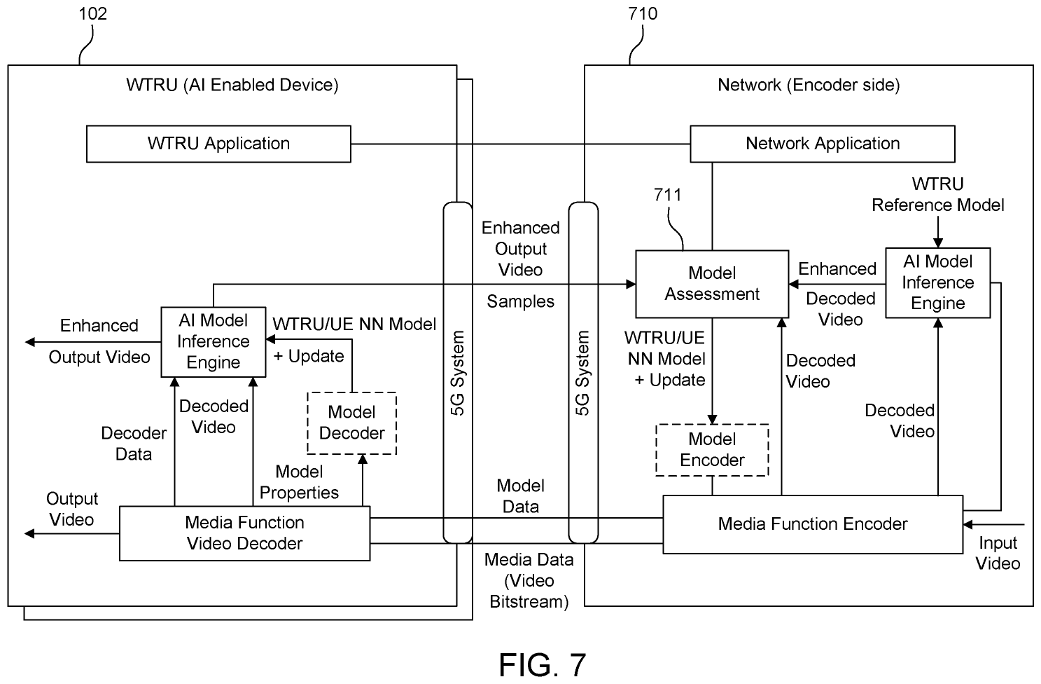

FIG. 7 shows an example of the service architecture for AI/ML model delivery applied to the post processing NN use-case, for example according to ongoing 3GPP SA4 architecture (FS_AI4Media).

A reference model running on the encoder side 710 may use the input video and the decoded video to produce a reference enhanced video locally. The reference model may be not or less limited with the resources in memory, time, energy to provide this reference enhanced video output.

Prior to assessment stage, the network (encoder side) may transmit a first trained model adapted to the WTRU.

According to an embodiment, the “model Assessment node” 711 located on the network (encoder side) may process iteratively any of the following actions during the assessment stage as follows:
Manages and/or configures the received sampling rate of individual enhanced video output frames produces by each WTRU.
Receives the enhanced video outputs samples from different device (WTRUs)
Assesses these samples against the outputs of the WTRU reference model running on the encoder side and possibly from the original decoded video itself. Assessment metrics may be based for example on SSIM (structural similarity index measure), PSNR (peak-signal-to-noise ratio) measurements.
Retrains the WTRU device model based on the collected data (e.g. from the recent samples of the video).
Computes new NN updates (e.g. weights, bias) resulting from the assessment process.
Delivers the NN updates to the WTRU.

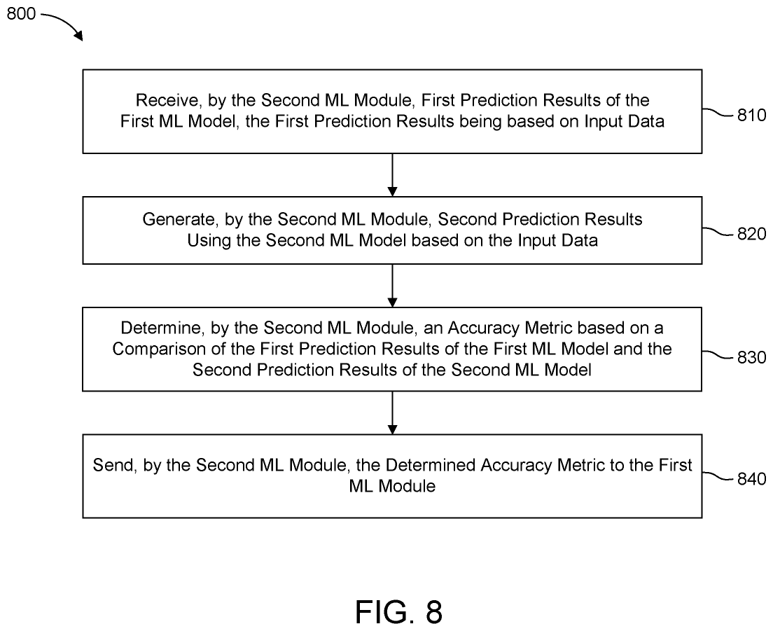

FIG. 8 is a flowchart illustrating a representative method of machine learning using a first ML module implementing a first ML model (e.g., production ML model) and a second ML module implementing a second ML model (e.g., reference ML model).

Referring to FIG. 8, the representative method 800 may include, at block 810, receiving, by the second ML module, first prediction results of the first ML model (for example, sent by the first ML module), the first prediction results being based on input data. At block 820, the representative method 800 may include generating, by the second ML module, second prediction results using the second ML model based on the input data. At block 830, the representative method 800 may include determining, by the second ML module, an accuracy metric based on a comparison of the first prediction results of the first ML model and the second prediction results of the second ML model. At block 840, the representative method 800 may include sending, by the second ML module, the determined accuracy metric to the first ML module.

In certain representative embodiments, the representative method 800 may further comprise executing, by the first ML module, the first ML model, wherein the first ML model is updated based on the determined accuracy metric and an accuracy condition.

In certain representative embodiments, the representative method 800 may further comprise updating, by the first ML module, the first ML model based on the determined accuracy metric and an accuracy condition.

In certain representative embodiments, the representative method 800 may further comprise executing, by the first ML module, the first ML model.

In certain representative embodiments, the first ML model and the second ML model may be implemented by a first WTRU.

In certain representative embodiments, the first ML model may be implemented by a first WTRU and the second ML model is implemented by a network device and/or a second WTRU.

In certain representative embodiments, the input data may be received from the first WTRU

In certain representative embodiments, the second ML model may have any of: (1) a greater accuracy than the first ML model for a predetermined validation data set, (2) a greater number of floating point operations (FLOPs), (3) a greater memory size.

In certain representative embodiments, the first ML model may be updated by selecting a third ML model among one or more candidate ML models.

In certain representative embodiments, the first ML model may be updated by retraining the first ML model, by the first ML module.

In certain representative embodiments, the representative method 800 may further comprise generating a dataset, the dataset may comprise input data associated with at least a second prediction result of the second prediction results generated by the second ML module.

In certain representative embodiments, the at least second prediction result may be associated with a confidence score.

In certain representative embodiments, generating the dataset further may comprise adding to the dataset the at least second prediction result, for example, based on the confidence score associated with the at least second predictions result.

In certain representative embodiments, the first ML model may be retrained, by the first ML module, for example, using the generated dataset.

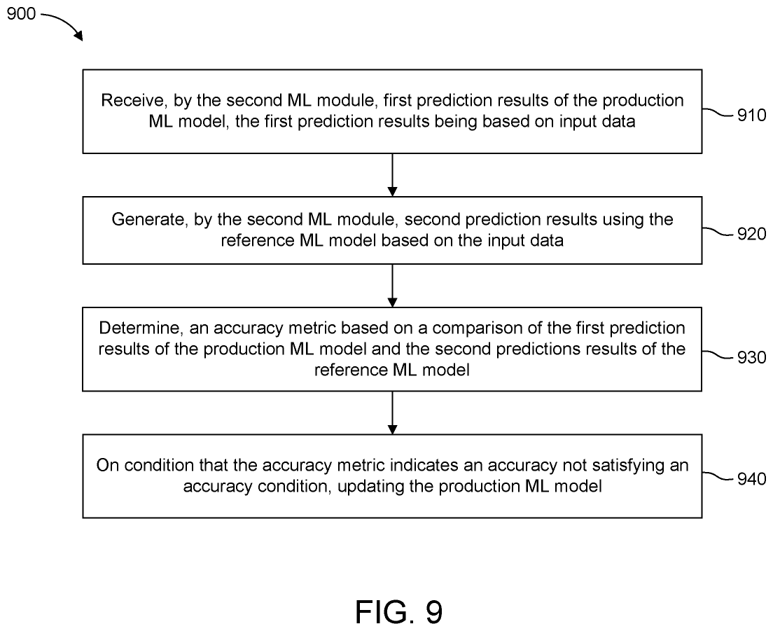

FIG. 9 is a flowchart illustrating a representative method of machine learning using a first ML module implementing a production ML model and a second ML module implementing a reference ML model, different from the production ML model.

Referring to FIG. 9, the representative method 900 may include, at block 910, receiving, by the second ML module, first prediction results of the production ML model, the first prediction results being based on input data. At block 920, the representative method 920 may include generating, by the second ML module, second prediction results using the reference ML model based on the input data. At block 930, the representative method 900 may include determining an accuracy metric based on a comparison of the first prediction results of the production ML model and the second predictions results of the reference ML model. At block 940, the representative method 900 may include on condition that the accuracy metric indicates an accuracy not satisfying an accuracy condition, updating the production ML model.

In certain representative embodiments, the reference ML model may have any of: (1) a greater accuracy than the production ML model for a predetermined validation data set, (2) a greater number of floating point operations (FLOPs), and/or (3) a greater memory size.

In certain representative embodiments, updating the production ML model may comprise selecting a new production ML model among one or more candidate ML models.

In certain representative embodiments, updating the production ML model may comprise retraining the production ML model, by the first ML module.

In certain representative embodiments, the representative method 900 may further comprise creating a dataset, the dataset may comprise input data associated with one or more second prediction results of the reference ML model generated by the second ML module.

In certain representative embodiments, a second prediction result of the reference ML model may be associated with a confidence score.

In certain representative embodiments, creating the dataset may further comprise adding a second prediction result of the reference ML model generated, by the second ML module, for example, on condition that the second predictions result is above a given a confidence score.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1. A method of machine learning performed by a wireless transmit receive unit (WTRU), the method comprising:
implementing, by a first machine learning (ML) module, a first ML model using input data to generate first prediction data, wherein the first ML model is a production model;
transmitting, to a second ML module at a network node, the input data and the first prediction data, wherein the second ML module includes a second ML model;
receiving, from the second ML module of the network node, an accuracy metric based on a comparison of the transmitted first prediction data of the first ML model and second prediction data obtained from the second ML model; and
updating the first ML model based on the received accuracy metric and an accuracy condition.

2. The method of claim 1, comprising:
executing, by the first ML module, the first ML model.

3-4. (canceled)

5. The method of claim 1, wherein the input data are received from the WTRU.

6. The method of claim 1, wherein the second ML model has any of: (1) a greater accuracy metric than the first ML model for a predetermined validation data set, (2) a greater number of floating point operations, and (3) a greater memory size.

7. The method of claim 1, wherein the first ML model is updated by at least one of (i) selecting a third ML model among one or more candidate ML models, and (ii) retraining the first ML model, by the first ML module.

8. The method of claim 1, further comprising generating a dataset, wherein the dataset comprises input data associated with at least a second prediction data of the second prediction data generated by the second ML module.

9. The method of claim 8, wherein the at least second prediction data is associated with a confidence score, and wherein generating the dataset comprises adding to the dataset the at least second prediction data, based on the confidence score associated with the at least second predictions data.

10. The method of claim 8, wherein the first ML model is retrained, by the first ML module, using the generated dataset.

11. A wireless transmit receive unit (WTRU) being configured to:
implement, by a first machine learning (ML) module, a first ML model using input data to generate first prediction data, wherein the first ML model is a production model;
transmit, to a second ML module at a network node, the input data and the first prediction data, wherein the second ML module includes a second ML model;
receive, from the second ML module of the network node, an accuracy metric based on a comparison of the transmitted first prediction data of the first ML model and second prediction data obtained from the second ML model;
update the first ML model based on the determined accuracy metric and an accuracy condition; and
execute the first ML model.

12. (canceled)

13. The WTRU of claim 11, wherein the input data are received from the WTRU.

14. The WTRU of claim 11, wherein the second ML model has any of: (1) a greater accuracy metric than the first ML model for a predetermined validation data set, (2) a greater number of floating point operations, and (3) a greater memory size.

15. The WTRU of claim 11, further configured to update the first ML model by at least one of (i) selecting a third ML model among one or more candidate ML models and by (ii) retraining the first ML model.

16. The WTRU of claim 11, being configured to generate a dataset, the dataset comprising input data associated with at least a second prediction data of the second prediction data generated by the second ML module.

17. The WTRU of claim 16, wherein the at least second prediction data is associated with a confidence score, and wherein the first ML module is configured to add to the dataset the at least second prediction data, based on the confidence score associated with the at least second predictions data.

18. The WTRU of claim 16, configured to retrain the first ML model using the generated dataset.

19-21. (canceled)
